(19) United States
(12) Patent Application Publication
(10) Pub. No.: US 2006/0064429 A1
(43) Pub. Date: Mar. 23, 2006

(54) Method and apparatus for providing assets reports categorized by attribute

(76) Inventor: Chi Yao, Cupertino, CA (US)

Correspondence Address: RONALD CRAIG FISH;RONALD CRAIG FISH, A LAW CORPORATION, POST OFFICE BOX 820, LOS GATOS, CA, 95032, US

(21) Appl. No.: 10/945,276

(22) Filed: Sep. 18, 2004

(51) Int. Cl. G06F 17/30

(52) U.S. Cl. 707/101

(57) ABSTRACT

A method and apparatus to allow users to specify search criteria in terms of asset type, attribute values, whether grouping by subcategory is desired, containment and location and for generating suitable search statements from user data so entered. The search statements are used to search a data warehouse of data records which defines instances of particular types of assets being monitored and relationships such as location, containment, owner, etc. Reports of number of records which match the search criteria are generated with subcategory counts for any grouping requests in said search criteria. Also disclosed is a process for building the data warehouse to support this type of querying and reporting.

### FIELD OF USE AND BACKGROUND OF THE INVENTION

The assignee of the present invention markets a product to help IT departments of corporations and governments manage their assets. According to a recent Gartner study, spending on IT assets such as hardware, software and communications equipment represents the largest IT budget category at 48% of the total. (Employee costs and external service providers, by contrast, represent approximately 38% and 11% of the budget, respectively). With overall IT budgets under the microscope recently, focus on IT asset governance has sharpened. Hence, most IT organizations have launched initiatives to manage their infrastructure costs while enhancing service levels, improving manageability and increasing compliance.

These strategic asset management initiatives include:
Eliminating or Redeploying Underutilized Assets
Renegotiating License or Maintenance Fees
Server Consolidation
Standardization and Compliance
Security Remediation
Configuration Management
Fixed Asset Reconciliation
Cross-Charging
Audit Compliance

To successfully plan and drive these initiatives, an IT organization needs very comprehensive visibility into its overall asset base. In addition, they need to incorporate external data such as vendor upgrade and support plans, vendor security flashes, asset purchase, depreciation and contractual information into the planning process.

However, IT organizations can rarely provide integrated information about their assets with the accuracy, detail and completeness needed to plan and drive these initiatives towards timely and optimal results. As a result, data collection takes 90% of the time and resources allocated to the initiative, but the collected information is still incomplete. As a result, strategic infrastructure initiatives have traditionally been very slow and difficult to plan and painful to implement and have achieved unsatisfactory results.

BDNA Corporation, the assignee of the present invention, markets a product to automate the collection of data about the assets of a corporation. In the prior art, IT departments spent 90% of their time collecting data manually about the assets of the organization. The BDNA asset governance product automates that data collection process and provides many analytics to analyze the resulting data so that IT departments can spend 90% of their time doing analysis of their data to implement initiatives instead of spending 90% of their time gathering data.

Large companies are turning to BDNA Corporation to quickly and accurately gain visibility into integrated information about their global infrastructure assets and then leverage its rich analytics to plan and drive their strategic asset initiatives.

By automatically collecting rich information about a company's assets into a data repository and providing the ability to run multidimensional analytics on this data, BDNA has become the technology platform to drive IT Asset Governance. Using BDNA, IT organizations are defining asset standards, monitoring compliance, managing exceptions, and creating and implementing directed initiatives—all within a single solution framework.

Reporting functions of the BDNA software allow a data warehouse built from the raw collected data to be mined to find out how many of various types of assets exist, where they are located, etc. However, there is still a need to provide a greater degree of granularity and flexibility in reporting the contents of the data gathered. For example, it is desirable to know for the asset class or type “server”, how many servers the organization has which have less than 2 CPUs, how many servers the organization has which have between 2 and 4 CPUs, and how many servers the organization has which have more than 4 CPUs.

Therefore, a need has arisen for an apparatus and method to mine the collected data to gather information about the attributes of various types of assets, collect them in “buckets” and provide a mechanism through a user interface for a user to specify upon which attributes the user would like to have greater detail in reports the user requests while managing assets. The applicant is not aware of any product which fills this need at this time.

### SUMMARY OF THE INVENTION

The teachings of the invention contemplate a genus of processes and apparatus in the form of programmed computers to carry out the genus of processes. The process genus is defined by the following characteristic steps which all species within the genus will share:
A) defining a specification of metadata that specifies all the different elements about which data is to be collected, the attributes thereof, any subcategories hereafter called buckets within a particular attribute into which a report is to be segmented and the semantics or name of each subcategory to be displayed on the report, and defining a path to a script that can control a collection server to gather data about each type element defined in said specification;
B) loading the metadata of said specification into a memory of a collection server;
C) loading scripts specified by metadata in said specification and executing said scripts to collect raw data;
D) building a data warehouse from collected raw data, and labelling or otherwise indicating which records in said data warehouse have attribute values which fall within buckets defined in said specification.
   Any computer programmed to carry out such a process is within the scope of the invention.

One species within this genus carries out step D in the genus of processes by performing the following steps:
accessing said specification and extracting bucket specifications therefrom and building a table of said bucket specifications;
inspecting raw data records collected using scripts and extracting records with attributes indicating they can be categorized by bucket or subcategory, hereafter referred to as bucketable records, and storing these records in an intermediate representation table;
accessing said table of bucket specifications and said intermediate representation table of bucketable records and generating several search statements that will be used to assign each record in said table of bucketable records to one or more buckets based upon attribute values of said record;
applying said search statements to records in said intermediate representation table to create one or more result tables of instance records that have attributes that are within one or more bucket definitions so as to assign instance records to buckets to which they belong; and
merging said result table into a main fact table in said data warehouse.

### BRIEF DESCRIPTION OF THE DRAWINGS

FIG. 1 is a diagram of a typical structure for an XML file which stores metadata which is used to configure the system and define the content of text that will be displayed on the user interface.

FIG. 2 is a flowchart of the overall process to generate an XML file specifying the elements about which data will be collected, specifying the attributes and buckets of each element and collecting the data, building a data warehouse and using it to make reports.

FIG. 3 is a more detailed flowchart of the process of building a portion of the data warehouse used for bucketization of reports represented by step 86 in FIG. 2.

FIG. 4 is a flowchart of the user interface that allows a user to invoke a report, define a query and its constraints and indicate which attributes and buckets are of interest and define containment and location constraints.

FIG. 5 is a diagram showing an exemplar query and a typical report that would result from such a query illustrating how the report is bucketized on the number of CPUs.

FIG. 6 is a diagram showing the actual format and syntax of the XML file of the preferred embodiment.

### DETAILED DESCRIPTION OF THE PREFERRED AND ALTERNATIVE EMBODIMENTS

IT departments need to collect data about the assets of the corporation and be able to browse the inventory and do reports to management for purposes of managing the corporation. One of the main reports is to group the collected assets by categories such as type, location, corporate divisions. The invention is to provide another option to the user to group assets in a report by attributes or value ranges. For example, it may be of interest to determine how many servers have more than 4 CPUs, how many servers have 2-4 CPUs and how many servers have less than 2 CPUs. The idea behind the invention is to examine the data collected about the assets of the corporation or government entity and further classify that data into “buckets” based upon attributes, said buckets being user defined but which can be automatically generated by the system in some circumstances where there are no classes of elements about which the system gathers data.

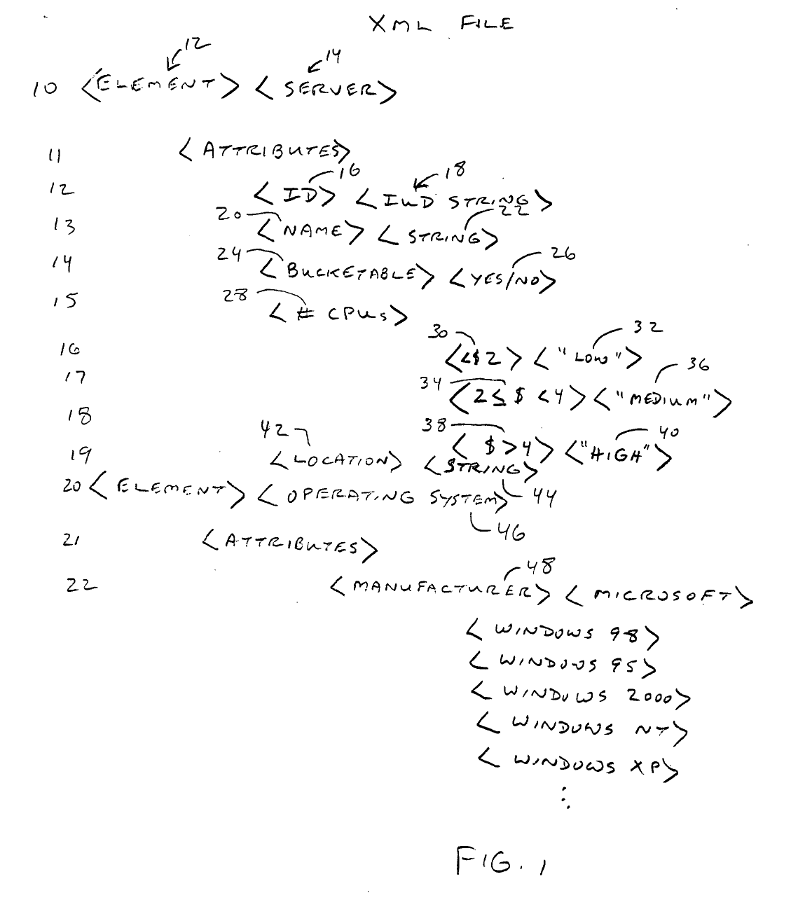

FIG. 1 is a diagram of a typical structure for an XML file which stores metadata which is used to configure the system and define the type of elements about which data will be gathered and the content of text that will be displayed on the user interface. Typically, there is one XML file that defines all the elements about which data will be gathered, but in other embodiments, there will be one XML file for each type element. An element is a type of an asset. Each type element is defined by a set of attributes. For example, an operating system is a type of element. Each different operating system has different attributes such as the manufacturer, the version, the cost, the number of CPUs the OS can simultaneously control, etc. Each attribute has subfields that further define that attribute. For example, each attribute has a name, whether it is bucketable, etc. If an attribute is bucketable, that particular line of the XML file may have subfields that define the name of different buckets and other subfields that define the text that will be displayed when the bucket is displayed. Typically, a bucket will be displayed with a number beside it, the number being the number of instances of that particular element type which have attributes that match that bucket definition.

This XML file configures the system and controls how it works on the raw data collected by the collection server. The entries in the XML file for each type of element defines what that element is. For example, a particular software program which is an asset of a company is defined by its name, version and cost. So the XML file will have an element called “software” and under that element there will be multiple sub elements for all the different types of software the company owns or leases. Each particular sub element will have attributes of “name”, “version” and “cost”. Each of these attribute lines will have a definition of what type of data is acceptable as the value of the attribute for a particular instance of that type software.

This XML file is written by the user, and the user defines the bucket attribute classifications manually. However, in some embodiments, some or all the bucket attribute definitions may be generated automatically. For example, in Oracle database software, there are many different versions, each defined by a string of characters to designate the version.

The user usually does not want to know how many Oracle database application programs of all versions it has, so each version is its own bucket and these buckets can be generated automatically by the system. This allows the user to make a query such as, “How many copies of the Oracle database software do I have, grouped by attribute ‘version’?”.

The XML file is comprised of entries for every different type of “element” in the data inventory, e.g., servers, operating systems, application software, desks, leases, copiers, fax machines, etc. The XML file is a pure text file which serves as a specification or template.

This specification defines the semantics, organization and data types of actual entries for particular instances of elements, said particular instances being stored in a data warehouse.

Elements are types of assets. Each type of asset has attributes. For example, servers have IDs, names, number of CPUs and locations. Line 10 of the XML file is an element “server” entry that defines one element about which the BDNA software will collect data as a server. Field 12 defines the semantics of the entry as an element, and field 14 defines the content of the field as a server. Line 10 basically defines that what follows until the next element entry on line 20 are lines that define the attributes of asset type server.

Line 11 is the beginning of the attribute fields for server type elements. These attribute fields define the types of data that are collected about each instance of the element type server. An instance of an element server means a server located someplace and having the named attributes. Line 12 is the first attribute, and field 16 gives the semantics or meaning of the first attribute: ID. Field 18 defines the data type for the actual IUD string which will uniquely identify an instance of an element type server in a data warehouse constructed from the raw data.

Line 13 defines the attribute “name” in field 20 and defines a data type string for the field “name” in field 22. Line 14 defines an attribute “bucketable” in field 24 and defines the data type as Boolean True or False, aka Yes or No in field 26. Line 15 defines the attribute “Number of CPUs” for element server in field 28, and lines 16, 17 and 18 defines bucket values for this attribute. The first bucket is defined on line 16 by field 30 as less than two. Field 32 defines the contents of what will display on the display the user observes when a report categorized by attribute Number of CPUs is run as “low”. In other words, on the report that reports the number of servers, a bucket for servers with less than two CPU will be displayed as a count of the number of servers with less than two CPUs and the semantics of this bucket will be “low”. The second bucket is defined on line 17 in field 34 as “greater than or equal to two and less than four”. Field 36 defines the semantics that will be displayed for this bucket as “medium” (both the count of instances of servers with the specified number of CPUs as well as the semantics are displayed typically). Line 18 defines the third bucket as servers with more than four CPUs in field 38, and defines the semantics that will be displayed with the count of servers with more than four CPUs as “high”.

Line 19 defines an attribute location in field 42 and defines the data type that will define the location as string in field 44.

Line 20 is the beginning of the specification for another type of element operating system (field 46), and line 21 is the beginning of the definition of attributes for type operating system. Line 22, field 48 defines the first attribute as the manufacturer. Bucket entries under line 22 define specific types of operating systems manufactured by Microsoft as Windows 98®, Windows 95®, Windows 2000®, Windows NT® and Windows XP®.

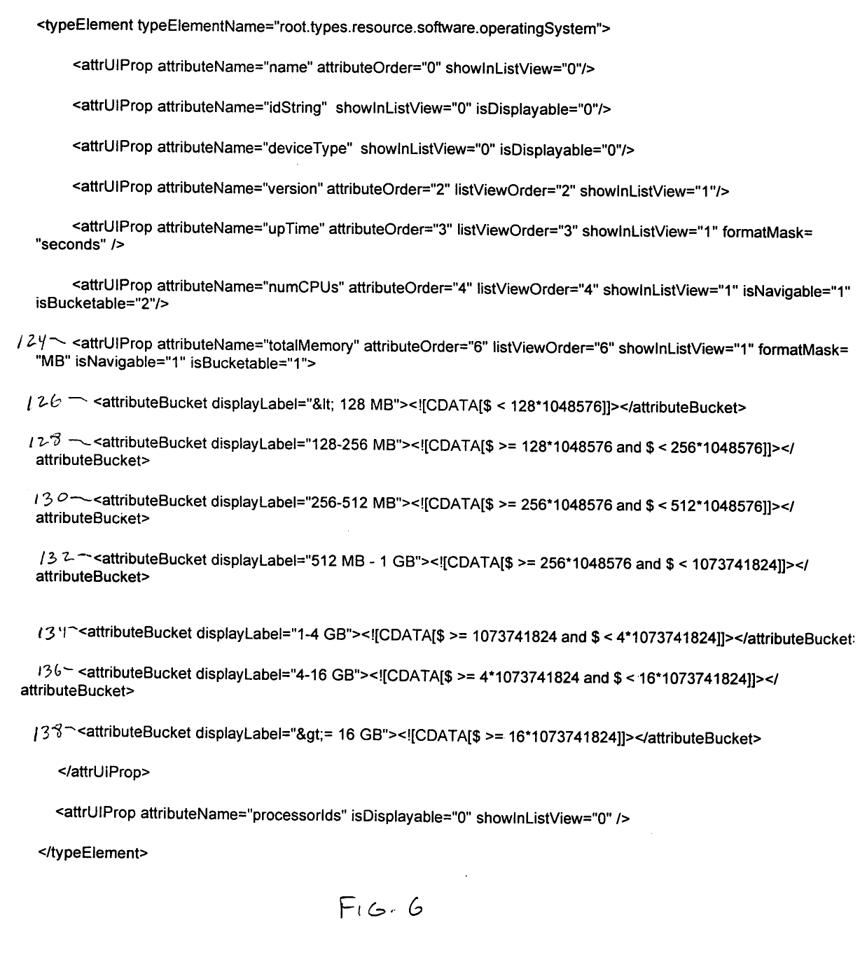

FIG. 6 is a diagram showing the actual format and syntax of part of an SML file defining several attributes on the type operating system. Each attribute can have various configuration parameters. Bucketing is one of these configuration parameters. For example, look at the “totalMemory” attribute defined at line 124. This attribute has its configuration paramter “is Bucketable” set to one which means the attribute is bucketable. Seven buckets are defined for this attribute at lines 126, 128, 130, 132, 134, 136 and 138. Each of these bucket definitions includes a display label and a math definition. For example, bucket 1 at 126 has a 128 MB label with a math expression of 128 times 1048576.

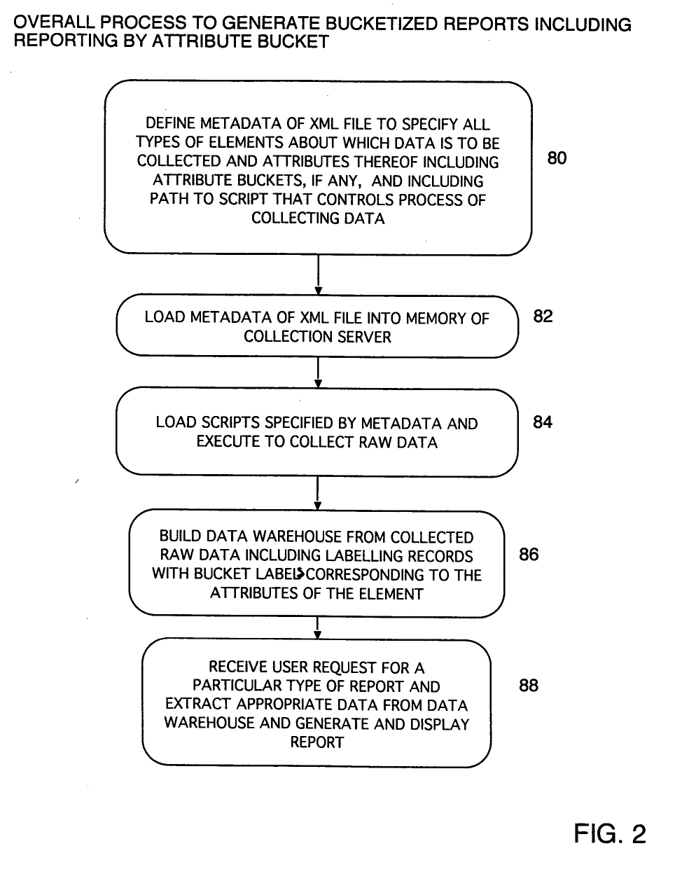

Referring to FIG. 2, there is shown a flowchart of the overall process to generate an XML file specifying the elements about which data will be collected, specifying the attributes and buckets of each element and collecting the data, building a data warehouse and using it to make reports. Step 80 represents the process of defining a specification of what data to collect in terms of metadata in an XML file. FIG. 1 is an example of a typical XML file of this type. The purpose of the XML file is to specify each element about which data will be automatically collected by the BDNA “Fingerprinting” software. The XML file also specifies which attributes about each element are of interest (semantics) and the data type to be stored for that attribute of each instance of such an element stored in a data “warehouse” (to be discussed further below). The invention described herein allows further categories to be defined within each attribute, and this process may sometimes be referred to herein as “bucketization” where a “bucket” is a subcategory within any particular attribute. For example, in FIG. 1 for the element “operating system”, there is an attribute manufacturer. Within the manufacturer attribute, there are several buckets defined for when the manufacturer is Microsoft, e.g., Windows 98, Windows 2000, Windows XP. It is the specification of these buckets which causes the system to collect the subcategory data and which enables the system to categorize assets in the bucket subcategories.

The XML file also includes a path or paths to the script or scripts which will be used to collect the raw data about each element.

Step 82 represents the process of loading the XML file metadata into the memory of the collection server to prepare it to collect raw data. Step 84 represents the process of using the path data XML file to access the script or scripts that define how data about each element and its attributes will be collected and using the scripts and the XML specification to access the attribute data and subcategory or bucket data specified for the element to which the script pertains.

Step 86 represents the process of building a data warehouse from data collected in step 84. The data warehouse is the raw data organized into a main fact table and other tables organized according to the specifications in the XML file. The main fact table contains records of every instance of every type of asset needed to support the types of reports or searches a user may define. In general, every query can be answered from the raw data but there are many steps which the computer must perform some of which can be shared for other queries. Therefor, the data warehouse is an intermediary representation of the raw data which is convenient for answering multiple different queries faster and which is built to facilitate sharing of steps which can be shared between different queries. The raw data collection is un-navigable because it does not allow aggregation, to browse or drill down on a particular dimension. The intermediate representation of the data warehouse allows this type of navigation activity. The data warehouse is completely tailored to the end user's user interface. In some embodiments, the data warehouse does not contain a copy of all the raw data but just includes pointers to the raw data for each entry in a database or table in the data warehouse. However, in the preferred embodiment, the raw data is copied into the data warehouse where appropriate to complete a data warehouse table entry or database record. The data warehouse builds a relationship between the target assets to be queried and a context. For example, a typical queries might be, “For our three local area networks, 1, 2 and 3, how many computers are coupled to local area network 3?”. The data warehouse would include a table for local area network 3 which has as its entries all the computers and other devices coupled to local area network 3. This table can then be queried directly or indirectly to make the requested report. The relationships or context which exist in the data warehouse are not present in the raw data and is usually implemented in table form with specific tables for specific contexts so that particular assets or elements can be grouped by type so this type can be queried by type or sub type. For example, the operating system element or type is arranged into one or more tables or counts for each of the different manufacturers of operating systems, e.g., Mac, Unix, Solaris, Microsoft etc. Generally, reports users request are concerned with dimensions of locations, types and attribute values. The data warehouse is built to facilitate navigation in response to report requests to allow element counts by locations, types and attribute values (bucketization) and to allow constraints to be built into the query. For example, a query might be, “Find me all the machines in the San Franscisco data center which have Oracle installed and then group by the division that owns them”. This query includes “container” relationship issues such as all the requested machines must have location San Francisco data center and must have attribute Oracle installed and requests bucketization into divisions that own the machines. These various attributes such as location, software installed, operating system manufacturer, OS version, number of CPUs, which network to which the machine is coupled are called dimensions. The data warehouse mines the raw data and builds tables or databases that include all these dimensions or relationships between machines, where they are located, what software applications they have installed on them, to which network they are installed and which division of the company owns or operates them so that such a query can be answered by searching the tables or databases of the data warehouse.

Typically, these relationships or dimensions can be recorded in the data warehouse by making a fact table with one column for each dimension with the semantics of that column naming the dimension. Each row would then contain an entry for one machine instance, and the columns of that row would be filled in with raw data that defines the particular dimensions for that particular machine.

Step 86 also represents the process of using the XML file bucket specifications to generate SQL language statements to search for data records in the data warehouse that meet the specifications of the buckets and label the records accordingly in the data warehouse to indicate to which bucket each instance record belongs. Once the records in the data warehouse are labelled with the buckets to which they belong, the report software can count them or do anything else required by the report to bucketize the various elements covered by the report.

In an alternative embodiment, step 86 can be modified to build a mini or partial data warehouse of only the data needed for a particularly requested report, and the process of building the mini data warehouse is carried out only when the user requests one of one or more predefined reports.

Step 88 represents the process of receiving a user request for a report, and extracting the appropriate data needed for the report from the data warehouse. The data so extracted is then organized per the specifications for the desired report and displayed including a display of any subcategories or buckets.

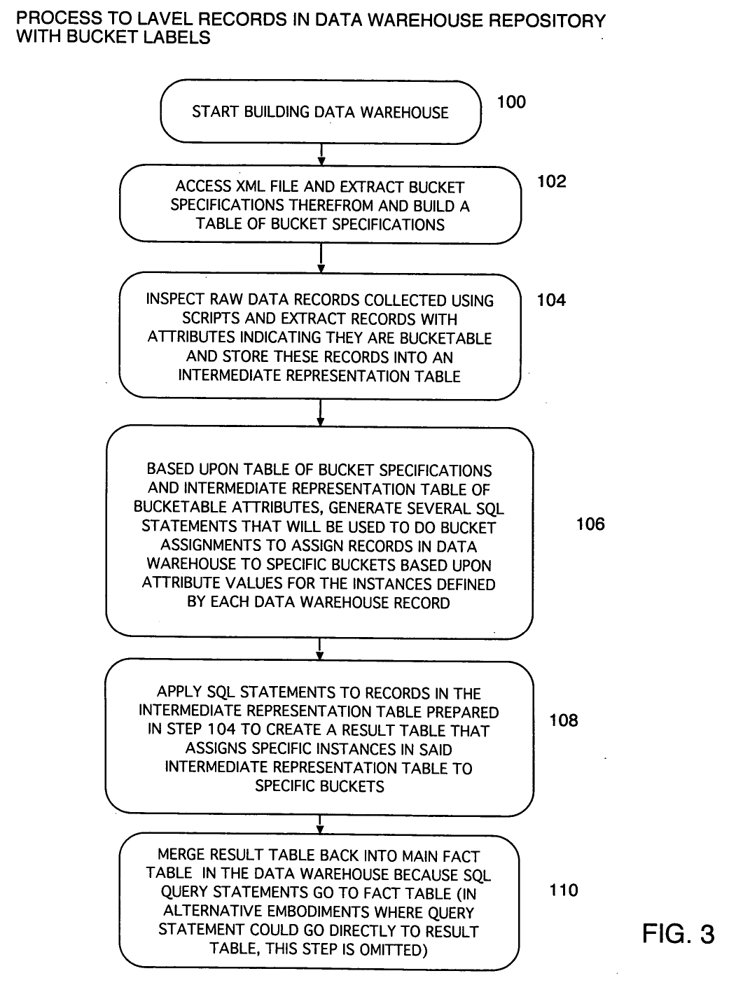

Referring to FIG. 3, there is shown a more detailed flowchart of the process of building a portion of the data warehouse used for bucketization of reports represented by step 86 in FIG. 2 (finding records which match bucket specifications and labelling records as being in this bucket in the data warehouse). The process starts out at block 100.

Block 102 represents the process of accessing the XML file and extracting the bucket specification therefrom. These bucket specifications are used to build a table in the XML file of bucket specifications. Reading the bucket specification means the entire XML file is read, and the bucket definitions for every bucket is stored in a bucket specification table. This is done so that one or SQL inquiry statements can be built later which incorporates specifications of the buckets so that one giant SQL statement can ultimately be built to apply to another table to be described below. This giant SQL statement will be applied to a table to determine which of its records have attributes which match a bucket specification. Building the bucket specification table makes it easier to build these SQL statements, but any way in which the proper inquiry statements to search the raw data or data in the data warehouse to find records which match the bucket specifications will suffice to practice the invention.

Block 104 represents the process of inspecting raw data records collected using the scripts and extracting records with attributes indicating they are bucketable. These extracted records are put into an intermediate representation table. The records in the raw data having attributes which are bucketable are a small subset of the total number of items of raw data. This step 104 finds records in the raw data which have attributes which are indicated as bucketable, copies them and stores them in an intermediate representation table.

Block 106 represents the process of generating several SQL statements to do the bucket assignments. Based upon the table of bucket specifications and the intermediate representation table of records in the data warehouse with bucketable attributes, several SQL statements are generated. It is these SQL statements that will be used to search the intermediate representation table of the data warehouse to assign specific records of the intermediate representation table to specific buckets based upon the attribute values for each instance record in the intermediate representation table. If more than one attribute has buckets or subcategories specified for it, the SQL statements do processing to assign the same instance to multiple buckets. The SQL statements basically encode the bucket specifications and contain the logic to compare each instance of an element in the intermediate representation table of the data warehouse and examine its attributes to determine if they match the bucket specifications. If a record does have attributes which match a bucket specification, the SQL statement contains the logic to modify the record of the instance in the intermediate representation table to assign it to the bucket it matches. Typically, the process is carried out in an interative manner where each iteration applies to one bucketable attribute and within each iteration, several SQL statements are generated. These several SQL statements do the work of finding target instances that match the bucket specification and assign the instance to the bucket.

This process of applying the SQL statements to the records in the intermediate representation table of the data warehouse and assigning records with attribute values which match the bucket specifications in the SQL statements to the matching bucket is represented by block 108. Typically, this is done by preparing a statement that says, “Instance ID xxx is assigned to bucket #1” where xxx is the ID of the record of the instance which has a bucketable attribute which matches the specifications for bucket #1. In an alternative embodiment, the records from the intermediate representation table that have an attribute which matches a bucket specification in an SQL statement are copied and stored in a result table in the process represented by block 108. In some embodiments, the result table just contains the statements like “Instance ID xxx is assigned to bucket #1” and the entire record which caused the hit is not copied into the result table.

Block 110 represents the process of merging the result table back into the main fact table in the data warehouse. This is done because the SQL statements generated when a report is requested search the main fact table for records that have attributes that match the search criteria established by the requested report and encoded into the SQL statements. The main fact table has a row for each instance of an element. Each column of the row has different semantics (the name of the attribute that defines the dimension) and each column contains data that defines the dimension value for this particular instance. In alternative embodiments where the search statements can search the result table, this step could be eliminated.

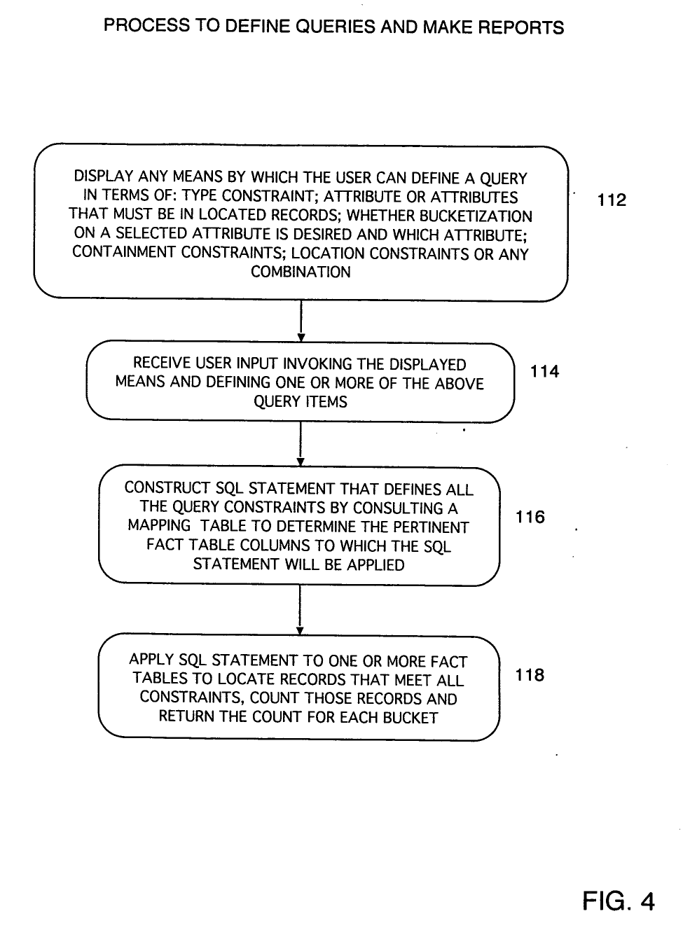

FIG. 4 is a flowchart of the user interface that allows a user to invoke a report, define a query and its constraints and indicate which attributes and buckets are of interest and define containment and location constraints. Reports are basically processes for counting or identifying instances of elements or types of assets that meet the search criteria.

For example, the user may want to know which or how many computers the companies own with Microsoft operating systems which are coupled to a particular local area network and which have Oracle database application software installed. The user may also want to bucketize the report to determine for example for the attribute “# of CPU” how many machines or which particular machines have a number of CPUs less than two, between two and less than four and equal to or more than 4.

Therefore, there must first be a means to display means the user can invoke to define what the search criteria are and indicate whether bucketization on a particular attribute is desired. This is symbolized by block 112 which basically symbolizes the process of a user requesting a report. A request for a report can be done either by specifying the various type, attribute, containment and location constraints manually or specifying a particular report which has a predetermined search query built into it with each different type of predefined report having a different predefined search query built into it.

To implement a user interface, the collection server or some client computer connected to it displays any form of user interface tool which can be invoked to allow the user to input data which defines one or more search query criteria. These user interface tools can be icons, drop down menus, command line interfaces, etc. The things a user can define for the search query include: type constraints which define the type of element the user is counting such as servers, operating systems, application programs etc.; the attribute or attributes which must be in the instance records in order for them to be counted; whether bucketization on a selected attribute is desired, and, if so, which attribute; any containment constraints (for example “what are the machines coupled to LAN #1 in the San Francisco data processing operation?”); any location constraints or any combination of the above.

Once the tools the user can use to define these search criteria are displayed, the user invokes them and enters data that defines the desired search criteria (block 114).

Block 116 represents the process of constructing an SQL statement that contains all the search criteria defined by the user. This is done by consulting a mapping table which defines which attributes are stored in which columns of the fact table. This is done to determine the pertinent fact table columns to be queried given the SQL statement's search criteria.

In block 118, the SQL statement is used to search the pertinent columns of the main fact table in the data warehouse to find instances of the specified element type which meet all the attribute, containment and location constraints. Then, if bucketization is desired, further searching among the instances with meant the other contraints is done to determine which of these instances have attributes which fall within the various bucket definitions. The application of the SQL statement causes the records that match the search query to be located, aggregated into the requested categories or buckets and the counts of the number of instances in each bucket is returned. Counts of the total number of records that meet the search query are also returned.

In other embodiments, the application of the search statement returns the records that match the search query or returns the IDs of the records that match the search query or returns the actual records or their IDs aggregated into groups of buckets as specified in the search statement.

In certain complex queries with one or more containment constraints, it may be necessary to search multiple fact tables in the data warehouse. For example, a search may start out by searching the type column of a first fact table to find instances of a particular type of element such as a server. Then among the located instances, the network column will be searched to find which of these servers is coupled to LAN #1. Then among these records, the SQL statement may go to the division column to determine which of these servers is operated by the marketing department if the user indicated this was one of the criteria of interest. Suppose, the query specifies the user want to know how many instances of servers with Oracle database software installed are running the Linux operating system at some particular location. If the main fact table does not contain data to satisfy all these queries, one or more other fact tables will have to be joined with the main fact table to add sufficient data to answer the query.

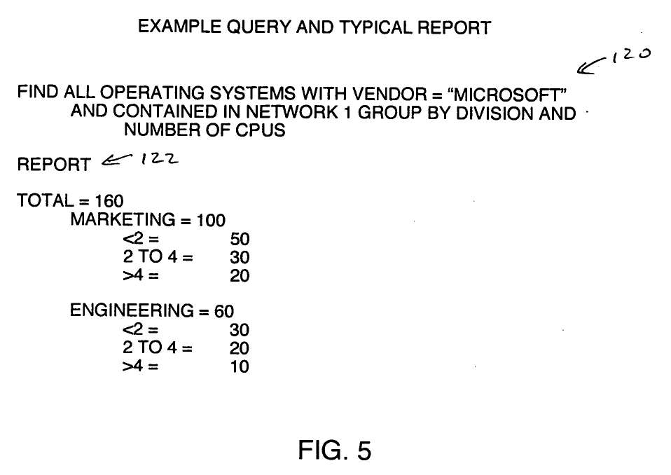

FIG. 5 is an example of a exemplar query which includes a containment constraint and a request to bucketize by number of CPUs and the report which is displayed to the user as a result of application of SQL statements embodying this query. The query is shown at 120. It requests a count of operating systems. More particularly, it requests a count of operating systems with attribute vendor=microsoft. The query also specifies a containment constraint. The operating systems which meet this query must be running computers which are coupled to network 1. Finally, the query asks for bucketization into subcategories of operating systems operated by each division of the company and, within each division, to group by number of CPUs the operating system can control.

The resulting report is shown at 122. It shows the total number of operating systems instances for operating system type asset found in the data warehouse that match the vendor and containment search criteria to be 160. Of those, 100 are operated by the marketing department, and of those, 50 control servers with less than 2 CPUs, 30 control servers with from 2 to 4 CPUs, and 20 control servers with greater than 4 CPUs. The report also shows the the Engineering department is operating 60 of the 160 total Microsoft operating systems connected to network 1. The report also shows that of those 60 which are operated by the Engineering department, 30 control servers with less than 2 CPUs, 20 control servers with from 2 to 4 CPUs, and 10 control servers with greater than 4 CPUs.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. For example, all the search query statements discussed herein were said to be SQL statements. This is because the raw data and the data warehouse instances are stored in Oracle databases. If some other database software is used, the search statements may be some other appropriate language. All such alternative embodiments and other modifications are intended to be included within the scope of the claims appended hereto.

What is claimed is:

1. A process for building a data warehouse that supports bucketization:
A) defining a specification of metadata that specifies all the different elements about which data is to be collected, the attributes thereof, any subcategories hereafter called buckets within a particular attribute into which a report is to be segmented and the semantics or name of each subcategory to be displayed on the report, and defining a path to a script that can control a collection server to gather data about each type element defined in said specification;
B) loading the metadata of said specification into a memory of a collection server;
C) loading scripts specified by metadata in said specification and executing said scripts to collect raw data;
D) building a data warehouse from collected raw data, and labelling or otherwise indicating which records in said data warehouse have attribute values which fall within buckets defined in said specification.

2. The process of claim 1 wherein said specification is defined by a user typing text into an XML file.

3. The process of claim 1 further comprising the step of using said data warehouse by receiving user requests for a report and extracting appropriate data from said data warehouse and generating and displaying a report.

4. The process of claim 1 wherein step D comprises the following steps:
accessing said specification and extracting bucket specifications therefrom and building a table of said bucket specifications;
inspecting raw data records collected using scripts and extracting records with attributes indicating they can be categorized by bucket or subcategory, hereafter referred to as bucketable records, and storing these records in an intermediate representation table;
accessing said table of bucket specifications and said intermediate representation table of bucketable records and generating several search statements that will be used to assign each record in said table of bucketable records to one or more buckets based upon attribute values of said record;
applying said search statements to records in said intermediate representation table to create one or more result tables of instance records that have attributes that are within one or more bucket definitions so as to assign instance records to buckets to which they belong; and
merging said result table into a main fact table in said data warehouse.

5. The process of claim 4 wherein said step of generating several search statements comprising generating SQL statements.

6. A process for interacting with a user to control a computer to define a search statement for searching a data warehouse and generating a report comprising the steps:
displaying any means which a user can invoke to start a dialog with a computer to enter data which defines search criteria including but not limited to: type of asset; attribute value or attribute values of interest; whether bucketization of said report is desired and, if so, upon which attribute is bucketization desired; containment constraints and location constraints;
receiving user input invoking one or more display means and specifying the desired criteria in terms of type, attribute or attributes value(s), whether bucketization is desired, and, if so, upon which attribute, containment constraints and location constraints or any combination of the above;
constructing an SQL statement based upon said user input by consulting a mapping table indicating which attributes are stored in which columns of a fact table in said data warehouse;
and, applying said SQL statement to one or more fact tables in said data warehouse to locate records that meet all search criteria, counting all such records and counting specific instances that fall withing each subcategory or bucket as specified in one or more grouping requests entered by a user; and
reporting at least the count for each bucket.

7. A programmed computer comprising:
a display;
a keyboard and pointing device;
a central processing unit coupled to said display and keyboard and pointing device, and controlled by an operating sytem, said central processing unit being further programmed to carry out the following process:
A) receiving user data defining a specification of metadata that specifies all the different elements about which data is to be collected, the attributes thereof, any subcategories hereafter called buckets within a particular attribute into which a report is to be segmented and the semantics or name of each subcategory to be displayed on the report, and defining a path to a script that can control a collection server to gather data about each type element defined in said specification;
B) loading the metadata of said specification into a memory of said computer;
C) loading scripts specified by metadata in said specification in said computer and and executing said scripts to collect and store raw data in said computer;
D) building a data warehouse from collected raw data, and labelling or otherwise indicating which records in said data warehouse have attribute values which fall within buckets defined in said specification.

8. A programmed computer comprising:
a display;
a keyboard and pointing device;
a central processing unit coupled to said display and keyboard and pointing device, and controlled by an operating sytem, said central processing unit being further programmed to carry out the following process:
displaying any means which a user can invoke to start a dialog with a computer to enter data which defines search criteria including but not limited to: type of asset; attribute value or attribute values of interest; whether bucketization of said report is desired and, if so, upon which attribute is bucketization desired; containment constraints and location constraints;
receiving user input invoking one or more display means and specifying the desired criteria in terms of type, attribute or attributes value(s), whether bucketization is desired, and, if so, upon which attribute, containment constraints and location constraints or any combination of the above;
constructing an SQL statement based upon said user input by consulting a mapping table indicating which attributes are stored in which columns of a fact table in said data warehouse;
and, applying said SQL statement to one or more fact tables in said data warehouse to locate records that meet all search criteria, counting all such records and counting specific instances that fall withing each subcategory or bucket as specified in one or more grouping requests entered by a user; and
reporting at least the count for each bucket.
